(19) United States
(12) Patent Application Publication
(10) Pub. No.: US 2016/0129899 A1
(43) Pub. Date: May 12, 2016

(54) DISPLAY DEVICE

(71) Applicant: YAZAKI CORPORATION, Tokyo (JP)

(72) Inventors: Taku Furuta, Aichi (JP); Masahiro Takamatsu, Shizuoka (JP); Eiji Shimochi, Shizuoka (JP)

(21) Appl. No.: 14/896,991

(22) PCT Filed: Jul. 7, 2014
(86) PCT No.: PCT/JP2014/068015

§ 371 Date: Dec. 9, 2015

(30) Foreign Application Priority Data
Jul. 9, 2013 (JP) 2013-143552

(51) Int. Cl. B60T 17/22; B60T 7/12

(52) U.S. Cl. CPC B60T 17/22; B60T 7/12

(57) ABSTRACT

A display device is provided with which even a driver who does not recognize a hill-start assist function can easily understand an operation condition when the hill-start assist function is operated. The display device includes an indicator mounted in the vehicle and an indicator-controlling unit to control the indicator. When the brake pedal is released in a state that the brake pedal is stepped on while the vehicle is stopped on the uphill road, the indicator-controlling unit displays a state that the hill-start assist function is operated in a character onto the indicator. Also, in the state in which the hill-start assist function is operated, the indicator-controlling unit displays the state in a character onto the indicator.

### TECHNICAL FIELD

The present invention relates to a display device. Specifically, the present invention relates to a display device mounted in a vehicle including a hill-start assist function to temporarily maintain a state in which a brake is applied even when a brake pedal is released while the vehicle is stopped on an uphill road.

### BACKGROUND ART

In a case where a vehicle is started on a hill, when a driver releases an accelerator pedal and steps on a brake pedal, the vehicle may temporarily move backward. Thus, a vehicle includes a hill-start assist function to prevent backward movement of the vehicle during a hill start and to make the hill start easy. When the hill-start assist function is operated during driving, a warning sound is output and warning light (slip warning light), such as what is illustrated in FIGS. 6A and 6B, in a meter is turned on during the operation of the function, whereby information is given to a driver.

In a control device for a vehicle described in Patent Literature 1, a name or an abbreviation of a system which can be operated or a name or an abbreviation of a mode of a system which can be set is displayed on a display along with a control state of a system related to an operation item (such as on/off state). Similarly, in a control device for a vehicle described in Patent Literature 2, a name or an abbreviation of a system which can be set is displayed on a display.

However, even when a name or an abbreviation of a system which can be set is displayed on a display, a hill-start assist function is not recognized much by a driver and there is a driver who cannot understand an operation condition thereof when the hill-start assist function is operated. As a result, there is a case where the driver becomes anxious.

### CITATION LIST

### Patent Literatures

Patent Literature 1: JP 2009-143354A

Patent Literature 2: JP 2009-143355A

### SUMMARY OF INVENTION

### Technical Problem

The present invention is to provide a display device with which even a driver who does not recognize a hill-start assist function can easily understand an operation condition thereof when the hill-start assist function is operated.

### Solution to Problem

The present invention is a display device mounted in a vehicle including a hill-start assist function to temporarily maintain a state in which a brake is applied even in a state in which a brake pedal is not stepped on while the vehicle is stopped on an uphill road, the display device including: an indicator mounted in the vehicle; and indicator-controlling unit configured to control the indicator, wherein when the brake pedal is released in a state in which the brake pedal is stepped on while the vehicle is stopped on the uphill road, the indicator-controlling unit displays a state, in which the hill-start assist function is operated, in a character onto the indicator and displays, in the state in which the hill-start assist function is operated, the state in a character onto the indicator.

In the present invention, when the brake pedal is released in the state in which the brake pedal is stepped on while the vehicle is stopped on the uphill road, and in the state in which the hill-start assist function is operated, the indicator-controlling unit displays an image and/or a video on the indicator in addition to the character.

### Advantageous Effects of Invention

According to the present invention, when a brake pedal is released in a state in which the brake pedal is stepped on while a vehicle is stopped on an uphill road, indicator-controlling unit displays a state, in which a hill-start assist function is operated, as a character onto an indicator. Thus, when the hill-start assist function is operated, an outline thereof is already recognized and it is possible to prevent a driver from becoming anxious even in a state in which the hill-start assist function is operated. Also, in a state in which the hill-start assist function is operated, the indicator-controlling unit displays the state (operation condition of hill-start assist function) in a character onto the indicator. Thus, for example, even a driver who does not recognize the hill-start assist function can easily understand the operation condition of the hill-start assist function. Thus, even in a state in which the hill-start assist function is operated, it is possible to prevent a driver from becoming anxious.

According to the present invention, when a brake pedal is released in a state in which the brake pedal is stepped on while a vehicle is stopped on an uphill road, and in a state in which a hill-start assist function is operated, an indicator-controlling unit displays an image and/or a video on an indicator in addition to a character. Thus, a driver can easily understand an outline and an operation condition of the hill-start assist function at a glance on the indicator. Thus, it is further possible to prevent a driver from becoming anxious.

### BRIEF DESCRIPTION OF DRAWINGS

FIG. 1 is a block diagram illustrating an embodiment of a display device of the present invention.

FIG. 2 is a front view of a meter DISP included in the display device illustrated in FIG. 1.

FIG. 3 is a flowchart illustrating a procedure for a controlling unit included in the display device illustrated in FIG. 1 to detect that a vehicle is stopped on an uphill road.

FIGS. 4A and 4B are views illustrating display examples of the display device illustrated in FIG. 1.

FIGS. 5A to 5D are explanatory views for describing an operation of the display device illustrated in FIG. 1.

FIG. 6A is a view illustrating a display example of a conventional control device for a vehicle and FIG. 6B is an enlarged view of FIG. 6A.

### DESCRIPTION OF EMBODIMENTS

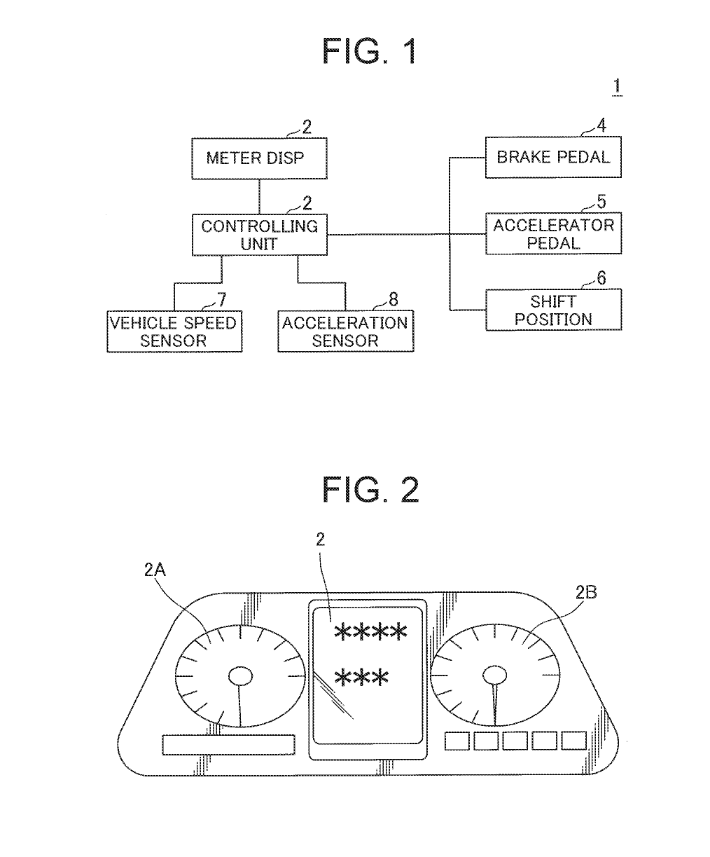

In the following, a display device according to an embodiment of the present invention will be described with reference to FIGS. 1 to 5.

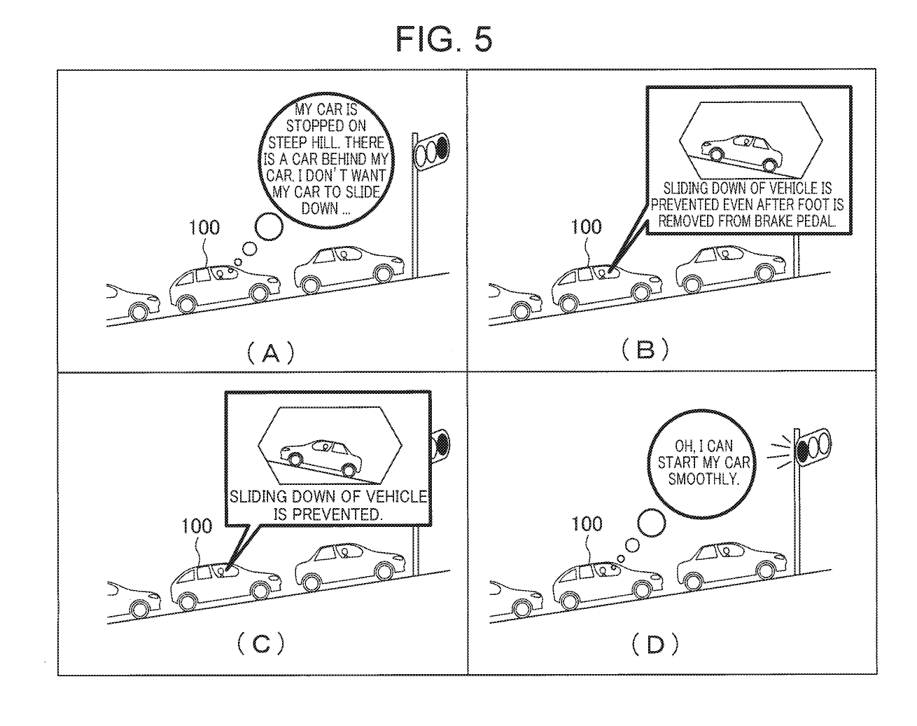

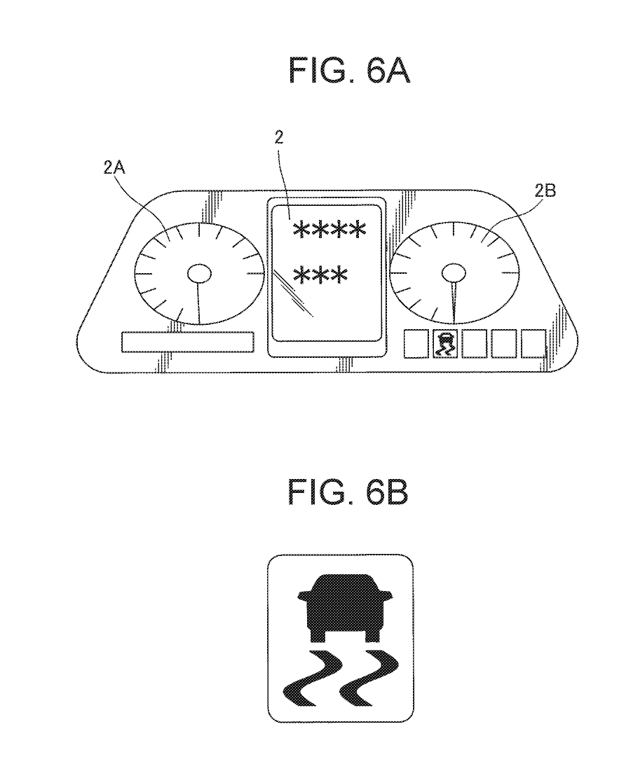

FIG. 1 is a block diagram illustrating a display device according to an embodiment of the present invention. As illustrated in the drawing, a display device 1 is mounted in a vehicle 100 (illustrated in FIGS. 5A to 5D) including a hill-start assist function to temporarily maintain a state in which a brake is applied even in a state in which a brake pedal 4 is not stepped on while the vehicle is stopped on an uphill road. The display device 1 includes a meter DISP 2 (example of “indicator”) and a microcomputer (μCOM) 3 to determine whether the hill-start assist function is executed (operated) and to display an outline and an operation condition of the hill-start assist function in a character onto the meter DISP 2. The μCOM 3 includes a central processing unit (CPU) to perform various kinds of processing or control according to a predetermined program, a ROM which is a read only memory storing a program or the like for the CPU, a RAM which is a readable/writable memory storing various kinds of data and having an area necessary for a processing operation of the CPU, and the like.

As illustrated in FIG. 2, the meter DISP 2 is arranged between a meter 2A and a meter 2B which are provided in an instrument panel of the vehicle 100 and which display speed and the like of the vehicle 100. The meter DISP 2 is connected to the CPU of the μCOM 3 to perform control of the meter DISP 2.

Moreover, as illustrated in FIG. 1, the μCOM 3 is connected to a brake pedal 4, an accelerator pedal 5, a shift position 6, a vehicle speed sensor 7 to detect a vehicle speed signal, and an acceleration sensor 8 to measure acceleration of the vehicle 100 and to determine whether a road is a uphill road.

Such a μCOM 3 executes the hill-start assist function when detecting that the brake pedal 4 is stepped on, the accelerator pedal 5 is not stepped on, the shift position 6 is in a position other than a parking position, the vehicle 100 is stopped, and the brake pedal 4 being stepped on is released, in a state in which the vehicle 100 is in a standby state on an uphill road according to a value of the acceleration sensor 8. Here, the μCOM 3 functions as indicator-controlling unit, detects the standby state, and displays an outline of the hill-start assist function in a character and as an image onto the meter DISP 2. Then, the μCOM3 displays an operation condition of the hill-start assist function in a character and as an image onto the meter DISP 2 during execution of the hill-start assist function.

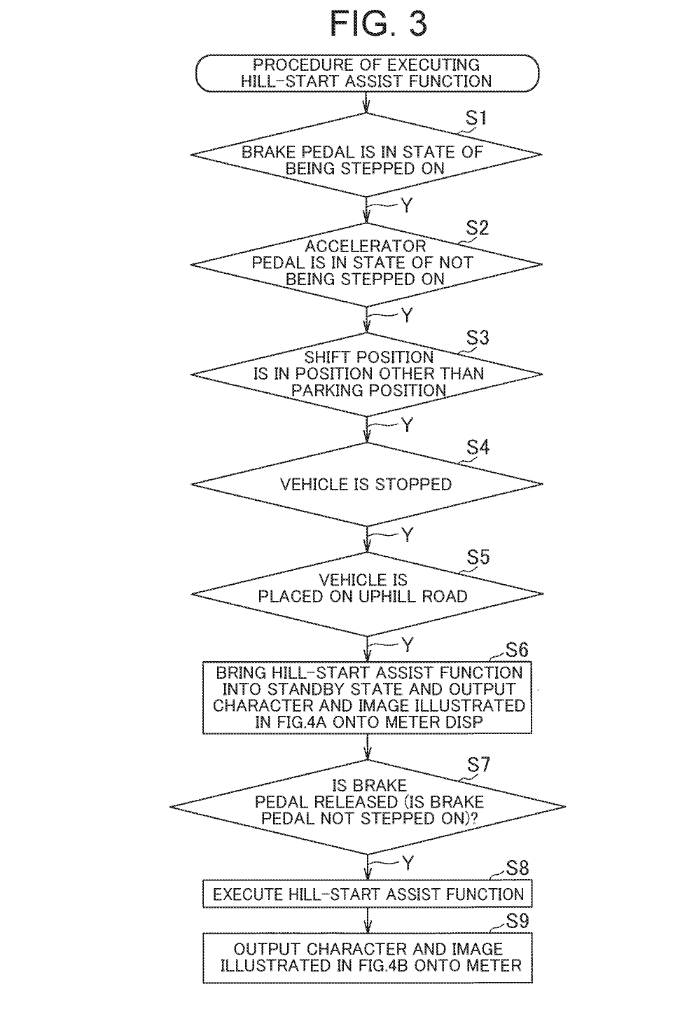

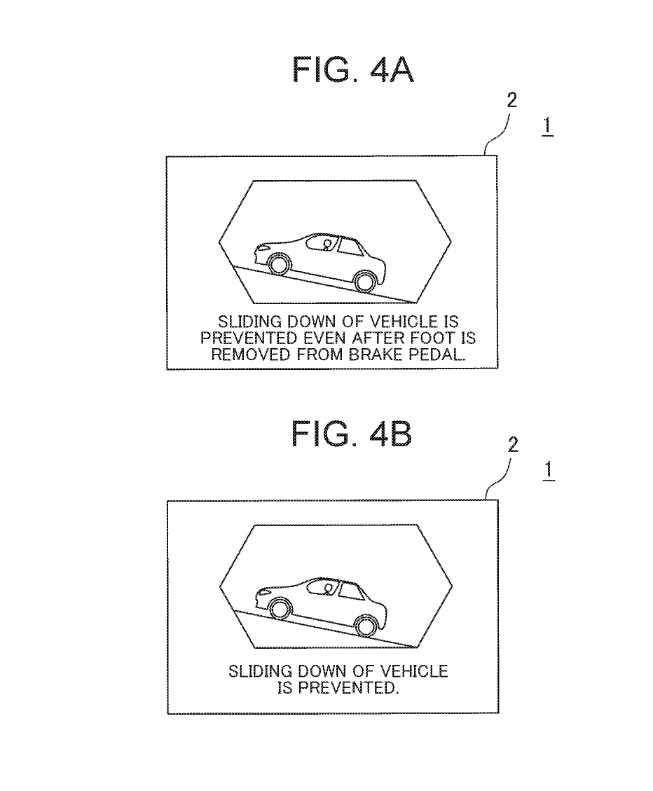

Next, an operation of the display device 1 with the above-described configuration will be described with reference to FIGS. 3 to 4B.

As illustrated in FIG. 3, when the μCOM 3 detects that the brake pedal 4 is stepped on (Y in step S1), the accelerator pedal 5 is not stepped on (Y in step S2), the shift position 6 is in a position other than the parking position (Y in step S3), the vehicle 100 is stopped (Y in step S4), and the vehicle 100 is placed on an uphill road (Y in step S5), the hill-start assist function becomes a standby state (step S6). Simultaneously, the μCOM 3 functions as the indicator-controlling unit, outputs an electronic sound from a speaker, and displays, on the meter DISP 2, characters indicating that “sliding down of the vehicle is prevented even after a foot is removed from a brake pedal” and an image such as what is illustrated in FIG. 4A. In such a manner, the display device 1 displays, on the meter DISP 2, a character and an image indicating an outline of the hill-start assist function when the hill-start assist function is in the standby state (before hill-start assist function is operated).

Then, the μCOM 3 detects that the driver removes his/her foot from the brake pedal (that brake pedal 4 is not stepped on) (Y in step S7) and executes the hill-start assist function (step S8). That is, even in a state in which the brake pedal 4 is not stepped on, a state in which the brake is applied is maintained for a predetermined period (a several seconds). Simultaneously, the μCOM 3 functions as the indicator-controlling unit, outputs an electronic sound from the speaker, and displays, on the meter DISP 2, characters indicating that “sliding down of the vehicle is prevented” and an image such as what is illustrated in FIG. 4B (step S9). In such a manner, in a state in which the hill-start assist function is operated, the display device 1 displays, on the meter DISP 2, a character and an image indicating an operation condition of the hill-start assist function. Then, the μCOM 3 detects that the accelerator pedal is stepped on by the driver, stops displaying the character and the image on the meter DISP 2, and goes back to step S1.

According to the above-described display device 1, when a brake pedal is released in a state in which the brake pedal is stepped on while a vehicle is stopped on an uphill road, the indicator-controlling unit displays a state, in which the hill-start assist function is operated, in a character onto the meter DISP 2 (indicator). Thus, when the hill-start assist function is operated, an outline thereof is already recognized and it is possible to prevent a driver from becoming anxious even in a state in which the hill-start assist function is operated. Also, in a state in which the hill-start assist function is operated, the indicator-controlling unit displays, onto the meter DISP 2, an operation condition of the hill-start assist function in a character. Thus, for example, even a driver who does not recognize the hill-start assist function can easily understand the operation condition of the hill-start assist function. Thus, even in a state in which the hill-start assist function is operated, it is possible to prevent a driver from becoming anxious.

Note that in the above-described embodiment, a character and an image are displayed on the meter DISP 2 (indicator), whereby a driver recognizes an outline or an operation condition of the hill-start assist function. However, the present invention is not limited to this. A video may be displayed on the meter DISP 2 and an outline or an operation condition of the hill-start assist function may be output as sounds from a speaker.

Also, the above-described embodiment only indicates a representative form of the present invention. The present invention is not limited to the embodiment. That is, it is possible to make various modifications within the spirit and the scope of the present invention.

### REFERENCE SIGNS LIST

1 display device
2 meter DISP (indicator)
100 vehicle

1. A display device mounted in a vehicle including a hill-start assist function to temporarily maintain a state in which a brake is applied even in a state in which a brake pedal is not stepped on while the vehicle is stopped on an uphill road, the display device comprising:
an indicator mounted in the vehicle; and
an indicator-controlling unit for controlling the indicator,
wherein when the brake pedal is released in a state in which the brake pedal is stepped on while the vehicle is stopped on the uphill road, the indicator-controlling unit displays a state, in which the hill-start assist function is operated, in a character onto the indicator and displays, in the state in which the hill-start assist function is operated, the state in a character onto the indicator.

2. The display device according to claim 1, wherein when the brake pedal is released in the state in which the brake pedal is stepped on while the vehicle is stopped on the uphill road, and in which the hill-start assist function is operated, the indicator-controlling unit displays an image and/or a video on the indicator in addition to the character.
